(19) United States
(12) Patent Application Publication
(10) Pub. No.: US 2005/0088908 A1
(43) Pub. Date: Apr. 28, 2005

(54) Apparatus for Cooling Concrete While in Mixing Chamber

(76) Inventor: David Alan Shelton, Nashville, AR (US)

Correspondence Address: DAVID ALAN SHELTON, 544 OLD CENTER POINT ROAD, NASHVILLE, AR, 71852, US

(21) Appl. No.: 10/905,423

(22) Filed: Jan. 3, 2005

Related U.S. Application Data
(60) Provisional application No. 60/544,942, filed on Feb. 12, 2004.

(51) Int. Cl. B01F 15/06

(52) U.S. Cl. 366/144

(57) ABSTRACT

A apparatus for cooling concrete while inside the concrete mixing chamber with a space related outer covering consisting of sections of mild steel welded around an existing portable mixing tank, a chamber access door located in the upper most rear of the mixing chamber for insertion of ice or CO2 pellets, a locking mechanism for securing the chamber door, a check valve located adjacent to the chamber access door for release of CO2 gases, a ball valve located at a 180 degree angle and on the opposite end of the mixing chamber from the access door for drainage of melted ice and a preferred embodiment includes the covering is made of galvanized iron, as well as stainless steel.

### DETAILED DESCRIPTION OF THE PREFERRED EMBODIMENTS

The following describes an embodiment of the present invention:

However, the following embodiment is only intended as a specific example illustrative of the technology involved in the apparatus of the present invention, and consequently, the apparatus of the present invention is in no way restricted to the materials, form, construction, or placement of structural parts described in the following. It is therefore to be understood that in the scope of the appended claims, the invention may be practiced other than specifically described.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

### BACKGROUND OF THE INVENTION

This invention relates generally to the field of construction and more specifically to an apparatus for cooling concrete while inside the concrete mixing chamber. This invention relates to an apparatus for making cooled pourable fresh concrete. It is desirable that the temperature of fresh concrete be low. In particular, the characteristics of concrete made in high ambient temperatures above 80 degrees F. are improved by cooling.

Specifically, hot weather concrete has the following drawbacks as referenced by ACI 305R-99, Hot Weather Concreting 1.3.1.
reduction in slump (slump being the height lost in a mound of concrete poured into a truncated conical form when the form is removed; the softer the concrete, the greater the slump);
Increased tendency for plastic-shrinkage cracking;
Increased rate of setting, resulting in greater difficulty with handling, compacting and finishing and a greater risk of cold joints;
Decreased 28-day and later strengths resulting from either higher water demand, higher concrete temperature, or both at time of placement or during the first several days;
greater variability of surface appearance, such as cold joints or color difference, due to different rates of hydration or different water-cementitious material ratios (w/cm);
increased potential for reinforcing steel corrosion, making possible the ingress of corrosive solutions; and
increased permeability as a result of high water content, inadequate curing, carbonation, lightweight aggregates, or improper matrix-aggregate proportions.

Water evaporation is responsible for slump reduction. For example, it is reported that 18 cm. Slump concrete has a 6 cm. Reduction in slump when agitated in a truck agitator for about one hour with an 86 degree F. (30 degree C.) temperature when mixed. When slump is reduced, pouring becomes difficult. It becomes necessary to add cement past and remix the concrete. Further, fresh concrete has the characteristic that even when the amount of added water is adjusted to be the same, the slump is still reduced as temperature is increased.

Cracking during hardening is caused by heat generation within the interior of the concrete. The hydration reaction that occurs when concrete hardens is an exothermic reaction. When heat is generated in the interior, a temperature differential is created between the interior and exterior surfaces of the concrete. Expansion of the heated interior and contraction of the cooled exterior generates cracks.

The cracking of concrete has detrimental effects on every application. Particularly, in the case of structures such as dams, bridge supports under the ocean, and walls of nuclear reactors, cracks can be a fatal flaw.

Further, hot weather concrete has reduced strength when hardened. Any damage to concrete caused by hot weather can never be fully alleviated as referenced ACI 305R-99, 1.5.

Drawbacks such as these can be eliminated by cooling the fresh concrete. Apparatus which cool the water added to the concrete have been developed for cooling fresh concrete. However, the temperature of the concrete cannot be cooled significantly by cooling the added water. This is because the amount of water added to the concrete is on 4% to 6% of the entire mixture.

Apparatus which cool the cement that is added to fresh concrete have also been developed. In these apparatus, the cement is forcibly cooled by blowing liquefied nitrogen gas into it. The apparatus have the feature that the cement can be cooled without adding water, but they have the drawback of extremely high running costs. The reason for this is the large consumption of expensive liquid nitrogen. Therefore, these apparatus can only be used for special purpose concrete.

An apparatus for cooling concrete while inside the concrete mixing chamber with a space related outer covering consisting of sections of mild steel welded around an existing portable mixing tank, a chamber access door located in the upper most rear of the mixing chamber for insertion of ice or CO2 pellets, a locking mechanism for securing the chamber door, a check valve located adjacent to the chamber access door for release of CO2 gases, a ball valve located at a 180 degree angle and on the opposite end of the mixing chamber from the access door for drainage of melted ice.

1. An apparatus for cooling concrete while inside the concrete mixing chamber comprising:
A continuous space related outer covering (set at a 6″ space) consisting of sections of mild steel welded together around an existing portable mixing tank mounted on a mobile vehicle;
A mild steel hinged chamber access door located in the upper most rear of the mixing of the mixing chamber for insertion of ice or CO2 pellets;
A locking mechanism for securing the chamber door;
A check valve located at a 180-degree angle and on the opposite end of the mixing chamber from the access door for drainage of melted ice.

2. The invention as claimed in claim 1 wherein said covering is made of galvanized iron.

3. The invention as claimed in claim 1 where said covering is made of stainless steel.

4. The invention as claimed in claim 1 wherein said covering is connected by means of a fastening mechanism consisting of bolts, flat washers, lock washers, nuts and gaskets.
